(19) United States
(12) Patent Application Publication
(10) Pub. No.: US 2023/0096964 A1
(43) Pub. Date: Mar. 30, 2023

(54) GRINDING APPARATUS

(71) Applicant: DISCO CORPORATION, Tokyo (JP)

(72) Inventors: Mitsuhiro NOMURA, Tokyo (JP); Masataka HIRAO, Tokyo (JP)

(21) Appl. No.: 17/934,358

(22) Filed: Sep. 22, 2022

(30) Foreign Application Priority Data
Sep. 27, 2021 (JP) 2021-156385

(51) Int. Cl. B24D 7/10; B24B 1/00; B24B 41/06

(52) U.S. Cl. CPC B24D 7/10; B24B 1/00; B24B 41/06

(57) ABSTRACT

A grinding apparatus includes a grinding water supply mechanism that includes a plurality of jet nozzles that jet grinding water to outside surfaces of grindstones, communication passages that make each of the jet nozzles and a water supply source communicate with each other, and valves disposed in the communication passages on a jet nozzle basis, in which opening and closing of the valves are controlled according to the position of the chuck table relative to the grindstones such that the grinding water is jetted only to that region of the grindstones that makes contact with a workpiece.

### BACKGROUND OF THE INVENTION

### Field of the Invention

The present invention relates to a grinding apparatus for grinding a workpiece.

### Description of the Related Art

Processing of grinding an upper surface of a workpiece from one end side toward the other end side by outside surfaces of grindstones, by moving a chuck table and rotating grindstones relative to each other in a horizontal direction, in a state in which the workpiece is held on a holding surface of the chuck table and lower surfaces (grinding surfaces) of the grindstones are positioned below the upper surface of the workpiece is called creep feed grinding (see, for example, Japanese Patent Laid-open No. 2017-056522).

In the grinding apparatus used for creep feed grinding, a grinding water nozzle for supplying grinding water to outside surfaces of the grindstones is provided, and removal of grinding swarf and removal of grinding heat are performed by the grinding water (see, for example, Japanese Patent Laid-open 2010-149222). The grinding water nozzle has a plurality of jet ports along the outside surfaces of the grindstones, grinding water is jetted to a maximum region of the grindstones making contact with the workpiece, whereby removal of grinding swarf and removal of grinding heat are carried out.

### SUMMARY OF THE INVENTION

However, in the creep feed grinding, despite that the region of the grindstones making contact with the workpiece varies with the progress of grinding, a fixed quantity of grinding water is always jetted. Therefore, when the region of the grindstones making contact with the workpiece is small, the grinding water is supplied also to that part of the grindstones which does not make contact with the workpiece, whereby the grinding water is jetted wastefully.

Accordingly, it is an object of the present invention to provide a grinding apparatus capable of supplying grinding water only to the region where the grindstones make contact with the workpiece, to thereby save the grinding water, in creep feed grinding.

In accordance with an aspect of the present invention, there is provided a grinding apparatus including a chuck table that holds a workpiece on a holding surface, a grinding unit that grinds a workpiece by use of grindstones mounted to a tip of a spindle in an annular pattern, and a moving mechanism that moves the chuck table and the grindstones relative to each other in a direction parallel to the holding surface, lower surfaces of the grindstones being positioned on an outer side than a peripheral edge of the workpiece held on the holding surface and below an upper surface of the workpiece, the chuck table and the grinding unit being moved relative to each other by the moving mechanism, to thereby grind the workpiece by outside surfaces of the grindstones, the grinding apparatus further including a grinding water supply mechanism that supplies grinding water to a region where the grindstones make contact with the workpiece, and a controller, in which the grinding water supply mechanism includes a plurality of jet nozzles that jet the grinding water to the outside surfaces of the grindstones, communication passages for making each of the jet nozzles and a water supply source communicate with each other, and valves disposed in the communication passages on a jet nozzle basis, wherein the controller controls opening and closing of the valves according to the position of the chuck table relative to the grindstones such that the grinding water is jetted only to that region of the grindstones that makes contact with the workpiece.

Preferably, an entrained air breaking unit that breaks entrained air formed in the same direction as the rotating direction of the grindstones is provided on the outside surface side of the grindstones.

Preferably, an example of the entrained air breaking unit is an entrained air breaking section disposed adjacent to the outside surfaces of the grindstones, or is an opposite direction jet nozzle that jets fluid in a direction opposite to the rotating direction of the grindstones along the outside surfaces of the grindstones.

In the present invention, controlling the opening and closing of the valves allows the grinding water to be supplied only to the region of the grindstones grinding the workpiece, so that the grinding water can be saved.

In addition, providing the entrained air breaking unit and breaking the entrained air prevent the supply of grinding water to the grindstones from being hampered; therefore, the quantity of grinding water jetted from the jet nozzle can be reduced, whereby the grinding water saving effect is more increased, and cooling of the grindstones and discharge of the grinding swarf can be realized even when the quantity of grinding water jetted is reduced.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view depicting an example of a grinding apparatus according to an embodiment of the present invention;

FIG. 2 is a perspective view depicting an example of a grinding water supply mechanism according to an embodiment of the present invention;

FIGS. 3A to 3C are plan views depicting stepwise states of grinding a circular workpiece by supply of grinding water to grindstones;

FIG. 3A is a plan view depicting a state in which grinding water is jetted from some of the jet nozzles at the time of starting grinding;

FIG. 3B is a plan view depicting a state in which the grinding water is jetted from all the jet nozzles during grinding;

FIG. 3C is a plan view depicting a state in which the supply of the grinding water from some of the jet nozzles is stopped;

FIGS. 4A to 4C are plan views depicting stepwise the states of grinding a rectangular workpiece by supply of grinding water to grindstones;

FIG. 4A is a plan view depicting a state in which the grinding water is jetted from some of the jet nozzles at the time of starting grinding;

FIG. 4B is a plan view depicting a state in which the grinding water is jetted from all the jet nozzles during grinding;

FIG. 4C is a plan view depicting a state in which the supply of the grinding water from some of the jet nozzles is stopped; and

FIGS. 5A to 5C are plan views depicting an example of an entrained air breaking unit.

### DETAILED DESCRIPTION OF THE PREFERRED EMBODIMENT

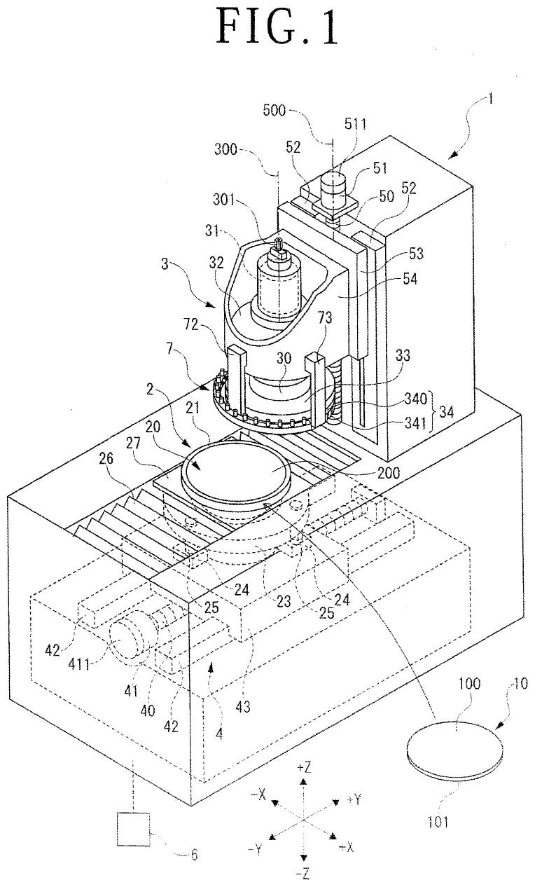

A grinding apparatus 1 illustrated in FIG. 1 is an apparatus for grinding a workpiece 10 held by a chuck table 2 by use of a grinding unit 3, the chuck table 2 can move in a Y-axis direction by being driven by a moving mechanism 4, and the grinding unit 3 can move in a Z-axis direction by being driven by a grinding feeding mechanism 5.

The chuck table 2 includes a suction section 20 formed of a porous member and a frame body 21 that holds the suction section 20, and the surface of the suction section 20 constitutes a holding surface 200 that holds the workpiece 10. The holding surface 200 and an upper surface of the frame body 21 are flush with each other.

A table base 23 is provided on a lower side of the chuck table 2, and is supported at at least three parts by three chuck support sections 24 (only two of which are depicted in FIG. 1). Each of the chuck support sections 24 is equipped with a load measuring instrument 25 for measuring a vertical load when the grinding unit 3 pushes the workpiece 10 held by the holding surface 200. In addition, at least two of the chuck support sections 24 have a function of adjusting the height of the chuck table 2 to adjust the inclination of the holding surface 200.

The grinding unit 3 includes a spindle 30 having a rotational axis 300 in the Z-axis direction; a spindle rotating mechanism 31 that rotates the spindle 30; a spindle housing 32 that supports the spindle 30 in a rotatable manner; a mount 33 connected to a lower end of the spindle 30; and a grinding wheel 34 mounted to the mount 33. When the spindle rotating mechanism 31 rotates the spindle 30, the grinding wheel 34 is also rotated. The grinding wheel 34 includes a base 340 fixed to the mount 33 and a plurality of grindstones 341 secured to a lower surface of the base 340 in an annular pattern. The outer peripheral side of the rotational locus of the grindstones 341 is substantially the same in diameter as the workpiece 10. In addition, an inflow port 301 for grinding water to flow in is provided at an upper end of the spindle 30.

The moving mechanism 4 includes a ball screw 40 having a rotational axis in the Y-axis direction, a motor 41 that rotates the ball screw 40, a pair of guide rails 42 disposed in parallel to the ball screw 40, and a slide plate 43 which has a bottom part in sliding contact with the guide rails 42 and which has therein an unillustrated nut screw-engaged with the ball screw 40. The chuck support sections 24 and the load measuring instruments 25 are disposed on an upper side of the slide plate 43. When the ball screw 40 rotates, the slide plate 43 is moved in the Y-axis direction by being guided by the guide rails 42, and, attendant on the movement of the slide plate 43 in the Y-axis direction, the chuck table 2 is also moved in the same direction. The frame body 21 is supported by the base 27 in a rotatable manner, a bellows 26 is connected to a side part of the base 27 in the Y-axis direction, and the chuck table 2 is moved in the Y-axis direction in association with contraction or extension of the bellows 26. The position of the chuck table 2 in the Y-axis direction is recognized by an encoder 411 provided on the motor 41.

The grinding feeding mechanism 5 includes a ball screw 50 having a rotational axis 500 in the Z-axis direction, a motor 51 that rotates the ball screw 50, a pair of guide rails 52 disposed in parallel to the ball screw 50, a lifting plate 53 which has a side part in sliding contact with the guide rails 52 and which has therein an unillustrated nut screw-engaged with the ball screw 50, and a holder 54 which is connected to the lifting plate 53 and which supports the spindle housing 32. When the ball screw 50 rotates, the lifting plate 53 is moved in the direction perpendicular to the holding surface 200 by being guided by the guide rails 52, and, attendant on this, the grinding unit 3 is also moved in the same direction, whereby the grindstones 341 are brought relatively closer to or away from the holding surface 200. The position of the grinding unit 3 in the Z-axis direction is recognized by an encoder 511 provided on the motor 51.

The grinding apparatus 1 includes a controller 6 that controls the chuck table 2, the grinding unit 3, the moving mechanism 4, and the grinding feeding mechanism 5. The controller 6 includes a central processing unit (CPU) and a storage element.

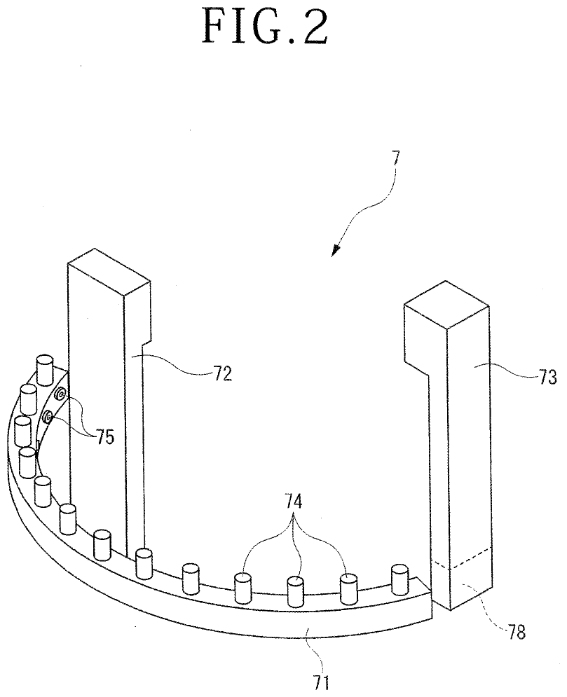

In the surroundings of the grinding wheel 34, there is disposed a grinding water supply mechanism 7 which covers half of the grindstones 341 from the outer peripheral side and which supplies grinding water to the outside surfaces of the grindstones 341. As depicted in FIG. 2, the grinding water supply mechanism 7 includes a main body section 71 formed substantially in a semi-arcuate shape, a first bracket 72 connected to an upper part of the main body section 71 and fixed to the holder 54 of the grinding feeding mechanism 5, and a second bracket 73 fixed to the holder 54 separately from the first bracket 72. Note that the second bracket 73 may be a separate body from the grinding water supply mechanism 7.

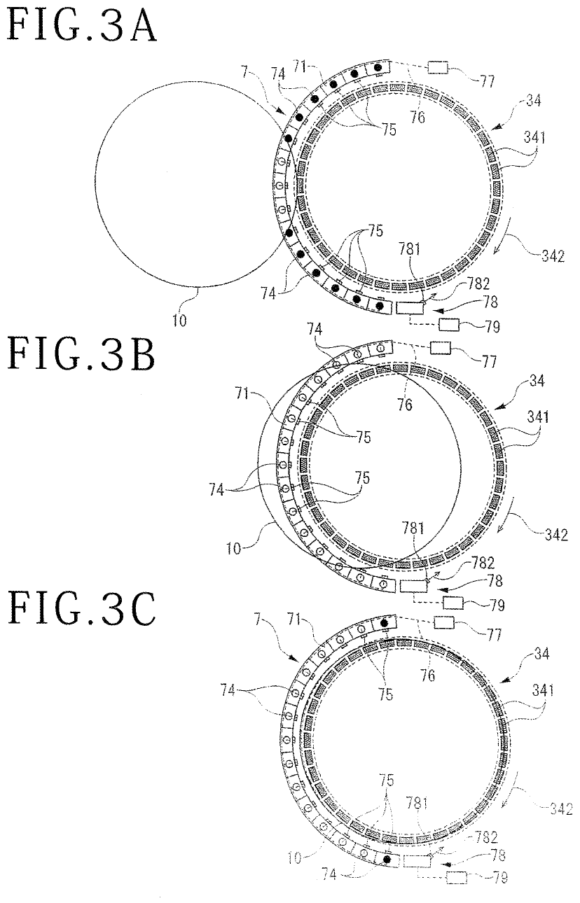

The radius of curvature of the inner circumference of the main body section 71 is greater than the radius of curvature of the outer circumference of the locus of the grindstones 341. A plurality of valves 74 are disposed at an upper part of the main body section 71. As depicted in FIGS. 3A to 3C, jet nozzles 75 directed toward the center of a circular arc are disposed on the inner peripheral side of the main body section 71. Communication passages 76 through which grinding water flows are formed inside the main body section 71, and all the jet nozzles 75 communicate with a water supply source 77 through the communication passages 76. Valves 74 are disposed in the communication passages 76 on an individual jet nozzle 75 basis, and the jetting of water from the individual jet nozzles 75 is controlled by the opening and closing of the valves 74.

At the lower end of the second bracket 73, there is provided an entrained air breaking unit 78 that includes an opposite direction jet nozzle 781. The opposite direction jet nozzle 781 communicates with an air source 79, and jets breaking air 782. Attendant on the rotation of the grindstones 341, entrained air 342 is generated along the outer circumference of the grindstones 341, and air jetted from the opposite direction jet nozzle 781 is jetted in the direction opposite to the entrained air 342, to break the entrained air 342.

When an upper surface 100 of the workpiece 10 is ground by use of the grinding unit 3, the lower surface 101 side of the workpiece 10 is held under suction on the holding surface 200 of the chuck table 2, while the upper surface 100 of the workpiece 10 is in an exposed state. Then, the chuck table 2 is moved in a direction parallel to the holding surface 200 by the moving mechanism 4, and all the grindstones 341 are positioned on the outer circumference side of the workpiece 10. In this instance, the chuck table 2 is not rotated. In addition, the spindle rotating mechanism 31 rotates the grinding wheel 34, the grinding feeding mechanism 5 progressively lowers the grinding unit 3, and the lower surfaces of the grindstones 341 are positioned below the upper surface 100 of the workpiece 10. The height position of the lower surfaces of the grindstones 341 is determined according to the amount of removal from the upper surface 100 of the workpiece 10.

Next, the moving mechanism 4 moves the chuck table 2 in a +Y direction, whereby the workpiece 10 is caused to progressively approach the grindstones 341. Then, immediately before the grindstone 341 near the workpiece 10 makes contact with the workpiece 10 as depicted in FIG. 3A, the valve 74 corresponding to the grindstone 341 by which grinding is conducted is opened under the control by the controller 6, and grinding water is jetted from the jet nozzle 75 facing the grindstone 341. Note that the valves 74 and the jet nozzles 75 may not correspond to each other in a one-to-one manner, and it suffices that the grinding water is jetted from the jet nozzle 75 toward the region where the grindstone 341 in charge of grinding is present. In FIGS. 3A to 3C, the valves 74 which are opened are indicated in white color, whereas the valves 74 which are closed are indicated in black color. In other words, a pair of two valves 74 disposed in symmetry with the moving direction (+Y direction) of the chuck table 2 as an axis of symmetry may be made to be one valve. For example, there may be adopted a configuration in which a pair of valves 74 indicated in black in FIG. 3C are one valve, and the jetting of grinding water from a pair of two jet nozzles 75 connected to the valve can be stopped.

When the moving mechanism 4 further moves the chuck table 2 at a predetermined velocity in the +Y direction, grinding of the workpiece 10 by the outside surface of the grindstone 341 being supplied with the grinding water is started. Then, when the chuck table 2 is further moved in the +Y direction, the number of the grindstones 341 making contact with the workpiece 10 increases progressively, and, attendant on this, the number of the valves 74 opened also increases progressively. Here, the controller 6 recognizes the position of the chuck table 2 in the Y-axis direction in reference to the value on the encoder 411 of the moving mechanism 4, and the relation between the position of the chuck table 2 in the Y-axis direction and the grindstones 341 which make contact with the workpiece 10 is stored beforehand in the controller 6. Hence, the controller 6, by controlling the opening and closing of the valves 74 according to the value on the encoder 411, can jet the grinding water from the jet nozzles 75 toward only the region where the grindstones 341 which make contact with the workpiece 10 are present, according to the position of the chuck table 2 in the Y-axis direction relative to the grindstones 341, whereby the grinding water can be saved.

When the number of the grindstones 341 making contact with the upper surface 100 of the workpiece 10 thus increases progressively, the number of valves 74 opened also increases gradually. When approximately one half the grindstones 341 are served to grind the workpiece 10 as depicted in FIG. 3B, attendantly all the valves 74 corresponding to the jet nozzles 75 facing one half the grindstones 341 are opened, and grinding water is jetted from all the jet nozzles 75 to be supplied to the grindstones 341 making contact with the workpiece 10.

When the grindstones 341 are rotated, entrained air 342 is formed in the rotating direction of the grindstones 341 and in the +Y direction, on the outside surface side of the grindstones 341. Since the entrained air 342 flows between the grindstones 341 and the jet nozzles 75, the entrained air 342 hampers the grinding water jetted from the jet nozzles 75 from reaching the grindstones 341. In view of this, during grinding, breaking air 782 is jetted in the opposite direction relative to the direction in which the entrained air 342 flows, from the opposite direction jet nozzle 781 of the entrained air breaking unit 78.

When the chuck table 2 is further moved in the +Y direction, all area of the upper surface 100 of the workpiece 10 is ground, as depicted in FIG. 3C. In this instance, only two of the valves 74 at both ends are closed. Then, when the chuck table 2 is further moved in the +Y direction, all the grindstones 341 no longer make contact with the workpiece 10, and all the valves 74 are closed.

Thus, opening and closing the valves 74 makes it possible to jet the grinding water from the jet nozzles 75 only to the region where the grindstones 341 that actually make contact with the upper surface 100 of the workpiece 10 to grind the upper surface 100 are present, and hence, the amount of the grinding water used can be minimized. In addition, since the entrained air 342 can be broken by the breaking air 782 jetted from the opposite direction jet nozzle 781, the grinding water can be supplied from the jet nozzles 75 to the grindstones 341 effectively, whereby the grindstones 341 can be cooled even with a small amount of grinding water (weak water flow), and grinding swarf adhering to the grindstones 341 can be discharged.

Note that while the jet nozzles 75 jet the grinding water in a direction parallel to the holding surface 200, the grinding water may be jetted downward, i.e., toward the upper surface 100 of the workpiece 10. In this case as well, the grinding water having flowed on the upper surface 100 can be made to reach the outside surfaces of the grindstones 341.

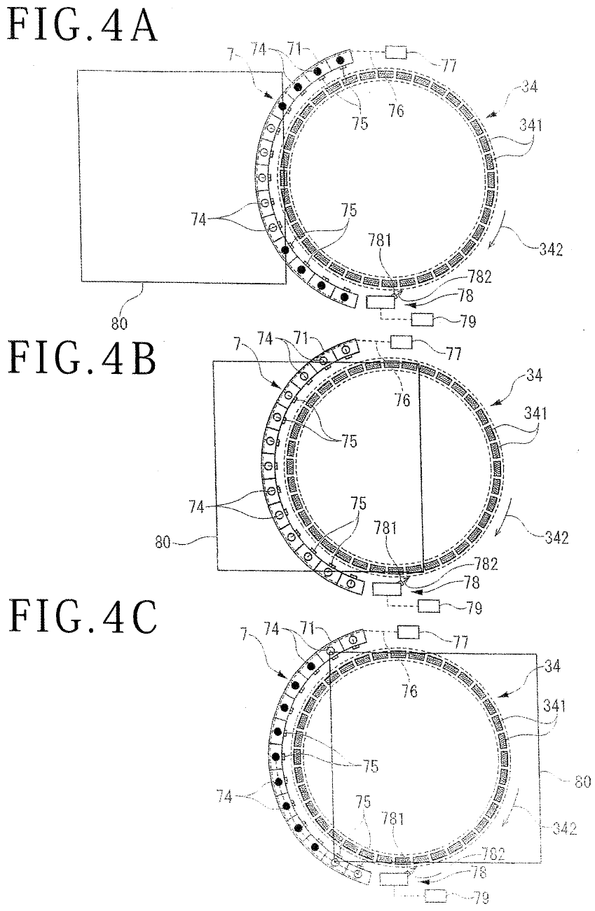

As illustrated in FIGS. 4A to 4C, a rectangular workpiece 80 can also be ground. In this case, in place of the chuck table 2 depicted in FIG. 1, a chuck table with a suction part formed in a rectangular shape is used. Also at the time of grinding the workpiece 80, the chuck table 2 is not rotated but is moved in the +Y direction parallel to the holding surface 200 by the moving mechanism 4, whereby the grindstones 341 are made to approach the workpiece 80. In addition, the spindle rotating mechanism 31 rotates the grinding wheel 34, the grinding feeding mechanism 5 progressively lowers the grinding unit 3, and the lower surfaces of the grindstones 341 are positioned below an upper surface 800 of the workpiece 80.

When the moving mechanism 4 progressively moves the chuck table 2 in the +Y direction, some of the grindstones 341 make contact with the workpiece 80, as depicted in FIG. 4A. Then, the corresponding valves 74 are opened under the control by the controller 6, such that grinding water is jetted from the jet nozzles 75 facing the grindstones 341 which make contact with the workpiece 80. In FIGS. 4A to 4C, also, of the valves 74, those which are to be opened are indicated in while color, whereas those which are to be closed are indicated in black color.

When the moving mechanism 4 further moves the chuck table 2 at a predetermined velocity in the +Y direction, grinding of the workpiece 80 by the outside surfaces of the grindstones 341 supplied with the grinding water is conducted. When the chuck table 2 is further moved in the +Y direction, the number of the grindstones 341 making contact with the workpiece 80 increases, and attendantly, the number of the valves 74 opened also increases gradually. When approximately one half the grindstones 341 are served to grind the workpiece 80, all the valves 74 corresponding to the jet nozzles 75 facing the approximately one half the grindstones 341 are opened, and grinding water is jetted from all the jet nozzles 75, whereby the grinding water is supplied to the grindstones 341 making contact with the workpiece 80.

During grinding, the breaking air 782 is jetted in the direction opposite to the direction in which the entrained air 342 flows, from the opposite direction jet nozzle 781 of the entrained air breaking unit 78. As a result, the entrained air 342 generated in the rotating direction of the grindstones 341 along the outside surfaces of the grindstones 341 is broken, and the grinding water jetted from the jet nozzles 75 can reliably be supplied to the grindstones 341.

When the chuck table 2 is further moved in the +Y direction, the number of the grindstones 341 that make no contact with the workpiece 80 progressively increases, as depicted in FIG. 4C, and, attendant on this, the valves 74 closed also increases progressively. Then, when all the grindstones 341 no longer make contact with the workpiece 80, all the valves 74 are closed.

Note that the chuck table 2 may include a plurality of holding surfaces that respectively hold a plurality of workpieces. As in the abovementioned description, the valves 74 are controlled such that the grinding water is supplied only to the region where the grindstones make contact with the workpiece.

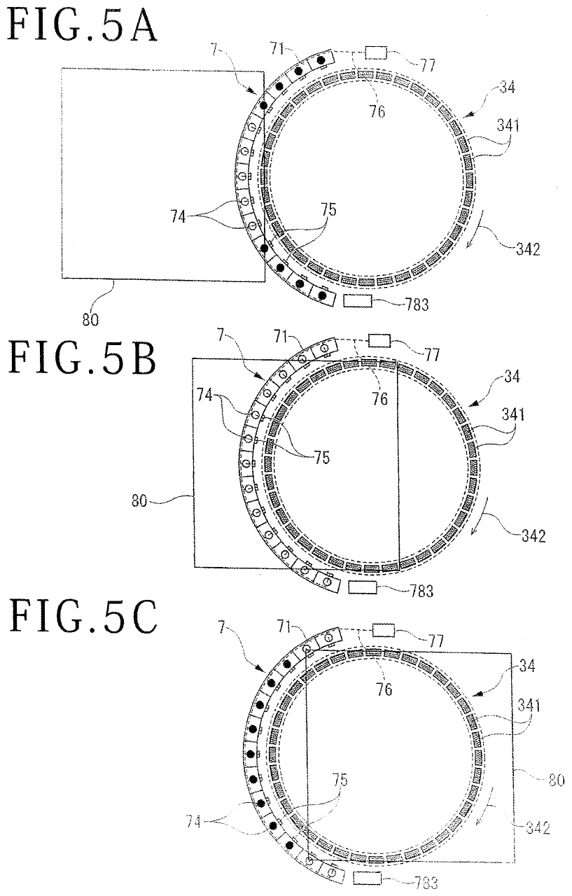

The opposite direction jet nozzle 781 depicted in FIGS. 3A to 3C and FIGS. 4A to 4C may jet breaking water instead of the breaking air 782. In addition, in place of the opposite direction jet nozzle 781, an entrained air breaking section 783 depicted in FIGS. 5A to 5C may be used. The entrained air breaking section 783 is a columnar member disposed adjacent to the outside surfaces of the grindstones 341 and does not have a function of jetting air, but is disposed in the moving path of the entrained air 342 to hamper the forward movement of the entrained air 342, thereby breaking the entrained air 342. Note that the embodiment illustrated in FIGS. 5A to 5C is configured similarly to the grinding water supply mechanism 7 depicted in FIGS. 3A to 3C and 4A to 4C, except the entrained air breaking section 783.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A grinding apparatus comprising:
a chuck table that holds a workpiece on a holding surface;
a grinding unit that grinds a workpiece by use of grindstones mounted to a tip of a spindle in an annular pattern; and
a moving mechanism that moves the chuck table and the grindstones relative to each other in a direction parallel to the holding surface,
lower surfaces of the grindstones being positioned on an outer side than a peripheral edge of the workpiece held on the holding surface and below an upper surface of the workpiece, the chuck table and the grinding unit being moved relative to each other by the moving mechanism, to thereby grind the workpiece by outside surfaces of the grindstones, wherein
the grinding apparatus further comprises:
a grinding water supply mechanism that supplies grinding water to a region where the grindstones make contact with the workpiece, and
a controller,
the grinding water supply mechanism includes
a plurality of jet nozzles that jet the grinding water to the outside surfaces of the grindstones,
communication passages for making each of the jet nozzles and a water supply source communicate with each other, and
valves disposed in the communication passages on a jet nozzle basis, wherein
the controller controls opening and closing of the valves according to a position of the chuck table relative to the grindstones such that the grinding water is jetted only to that region of the grindstones that makes contact with the workpiece.

2. The grinding apparatus according to claim 1, further comprising:
an entrained air breaking unit that breaks entrained air formed in a direction same as a rotating direction of the grindstones, on the outside surface side of the grindstones.

3. The grinding apparatus according to claim 2, wherein the entrained air breaking unit is an entrained air breaking section disposed adjacent to the outside surfaces of the grindstones.

4. The grinding apparatus according to claim 2, wherein the entrained air breaking unit is an opposite direction jet nozzle that jets fluid in a direction opposite to the rotating direction of the grindstones along the outside surfaces of the grindstones.
